(19) United States
(12) Patent Application Publication
(10) Pub. No.: US 2015/0360708 A1
(43) Pub. Date: Dec. 17, 2015

(54) SHOPPING CART SYSTEM

(71) Applicant: Pamela Benton, Haines City, FL (US)

(72) Inventor: Pamela Benton, Haines City, FL (US)

(21) Appl. No.: 14/305,264

(22) Filed: Jun. 16, 2014

(51) Int. Cl. B62B 5/00; A61G 5/10; G07F 17/00; B62B 3/00

(52) U.S. Cl. CPC B62B 5/002; B62B 5/0033; B62B 3/004; A61G 5/10; G07F 17/0057

(57) ABSTRACT

A shopping cart adapted for use by a person in a wheelchair is disclosed. The shopping cart can include a basket having a rear panel that is releasably fixed in a first position and can be released from the first position and lowered to a second position. The shopping cart can also include a plurality of attachment members adapted to attach to the frame of a wheelchair.

Embodiments relate generally to shopping carts and more particularly to a shopping cart system adapted for use by a person in a wheelchair.

Conventional shopping carts may not be usable by a person in a wheelchair. Motorized scooters and other devices have been developed to address the needs of persons confined to a wheelchair when shopping. However, these other systems have certain limitations or problems. For example, motorized shopping carts may be provided in a limited number in a store and may be difficult for a person in a wheelchair to use as the person would have to get out of their wheelchair and into the motorized cart and this may not be possible for all persons that use a wheelchair.

Embodiments were conceived in light of the above-mentioned problems and limitations, among other things.

An embodiment can include a shopping cart system having a cart that is attachable to a wheelchair. The cart can include a basket having a rear panel that lowers to allow a person in a wheelchair to place items into the shopping cart basket from the rear of the shopping cart. The cart can be adapted to be dispensed by a dispensing device that is coupled to a system for recognizing that a customer has a need to use the shopping cart adapted for use with a wheelchair. For example, a person may have an identification card issued by the government or issued by a store that identifies the person as confined to a wheelchair and needing to use the shopping cart adapted for a wheelchair when shopping in the store. In this way, the shopping carts adapted for use by persons in a wheelchair will limited and dispensed on an as needed basis for customers having the identification card. The dispenser recognizes the identification card and releases one of the shopping carts for use by the customer.

The shopping cart is attachable to the wheelchair, for example the shopping cart can include two bars with attachment points on each end that couple to the frame of the wheelchair. In this way, the customer can operate the wheelchair and push the cart forward at the same time without having to use his/her hands to hold or push the shopping cart.

The shopping cart can also include a power assist module that provides electrical power assistance to the shopping cart wheels to lessen the load or burden of pushing the shopping cart for the person in the wheelchair. The shopping carts can be recharged when nested together at the front of the store in the dispensing system. In other words, the dispensing system can also include a charging module and appropriate electrical connection such that when the shopping carts are returned to the dispensing system and inserted in a nesting arrangement electrical connection is made to a charging apparatus that will recharge the battery for the power assist system.

### BRIEF DESCRIPTION OF THE DRAWINGS

FIG. 1 shows a side elevation view of a wheelchair coupled to a shopping cart adapted for use with a wheelchair in accordance with at least one embodiment.

FIG. 2 shows a top elevation view of a wheelchair coupled to a shopping cart in accordance with at least one embodiment.

FIG. 3 shows a side elevation view of a shopping cart coupled to a wheelchair with the rear basket gate of the shopping cart in a lowered position.

FIG. 4 shows a group of shopping carts in a shopping cart dispensing system in accordance with at least one embodiment.

FIG. 5 shows shopping carts nested and docked in a charging system in accordance with at least one embodiment.

FIG. 6 shows a power assisted shopping cart in accordance with at least one embodiment.

FIG. 7 shows a side elevation view of a wheelchair coupled to a shopping cart adapted for use with a wheelchair in accordance with at least one embodiment.

### DETAILED DESCRIPTION

It will be appreciated that shopping cart embodiments can be different sizes and attach to a wheel chair facing toward or away from the wheelchair. Also, a larger cart embodiment can be used when a person is assisting the person in the wheelchair.

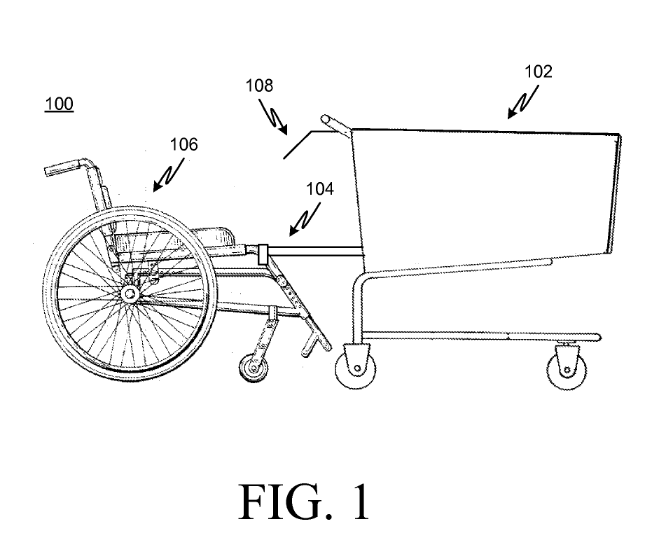

As shown in FIG. 1, a shopping cart system 100 adapted for use with a wheelchair includes a shopping cart 102 having connection members 104 for connecting to a wheelchair 106. In operation a user or customer in the wheelchair 106 approaches the shopping cart 102 and attaches the connecting members 104 to the wheelchair frame once the connecting members have been attached to the wheelchair frame the customer can operate the wheelchair as normal with the connecting members pushing and directing the shopping cart as the customer operates their wheelchair in the normal manner. The shopping cart 102 also includes a rear gate handle 108 for lowering and raising a rear gate of the shopping cart 102.

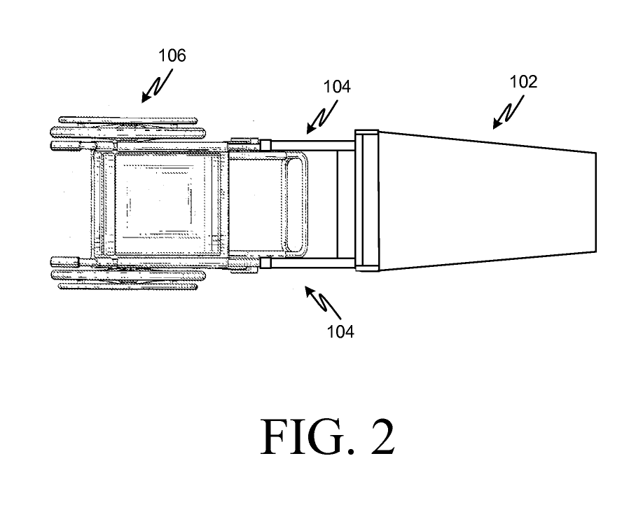

FIG. 2 shows the top view of the shopping cart 102 coupled to the wheelchair 106 via the connecting members 104.

It will be appreciated that the connecting members can be made of any suitable materials such as metal, plastic, or the like. The connecting members can have a connecting portion at the end for coupling to the wheelchair frame the connecting portion can be made of any suitable connecting means for attaching to a wheelchair frame.

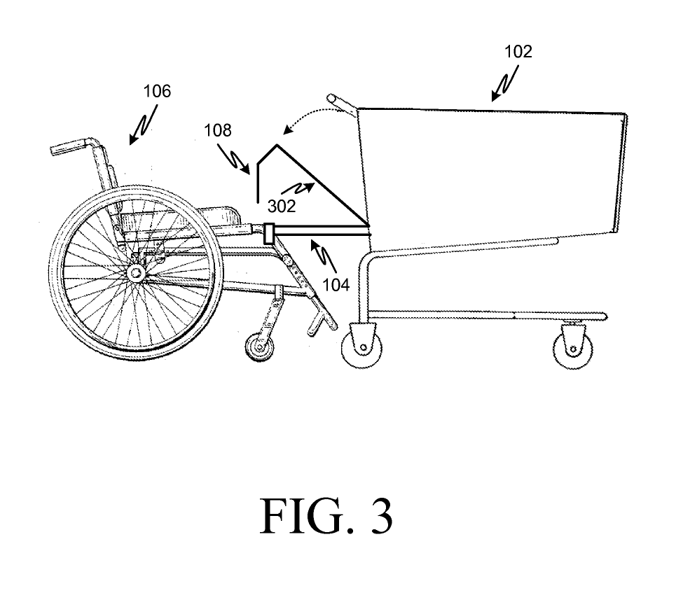

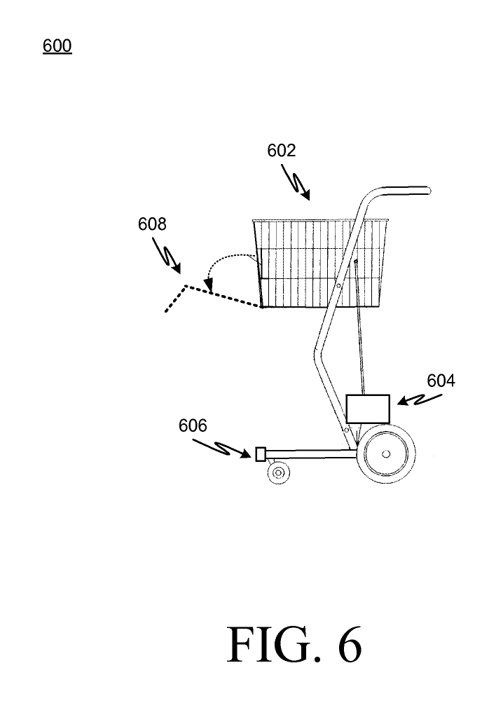

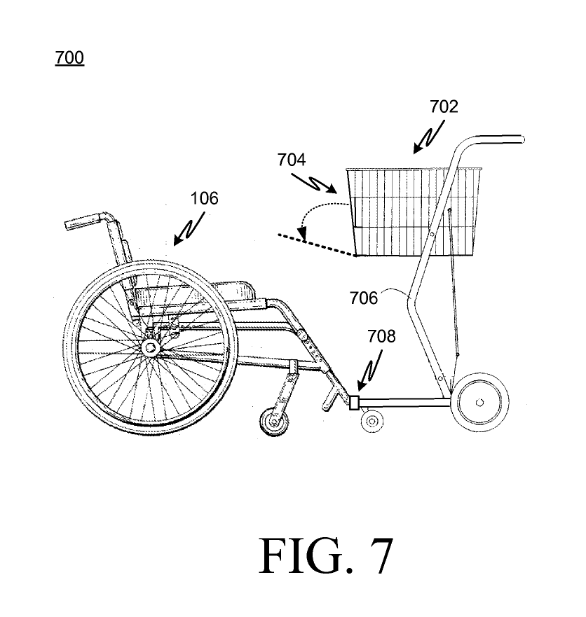

FIG. 3 shows shopping cart 102 with a rear basket gate 302 in a lowered position. In operation a customer in the wheelchair 106 can lower the handle 108, which in turn lowers the rear gate 302 of the shopping cart in order to place items into the shopping cart in order to prevent the need to reach into the shopping cart, the customer could also place items on rear gate 302 and raise rear gate to a closed position causing the items to move forward into the shopping cart as the gate is raised. The gate shown in FIG. 3 could also be used with the embodiments shown in FIGS. 6 and 7, where the gate would open on the side of the basket facing the person in the wheelchair.

The shopping cart can also include a removable gripping apparatus (not shown) that can be used by a customer for placing items further into the shopping cart. In other words, the gripping apparatus can extend the reach of the customer and allow the customer to move grocery items further forward in the cart than they would normally be able to reach with their arms alone from a seated position in a wheelchair.

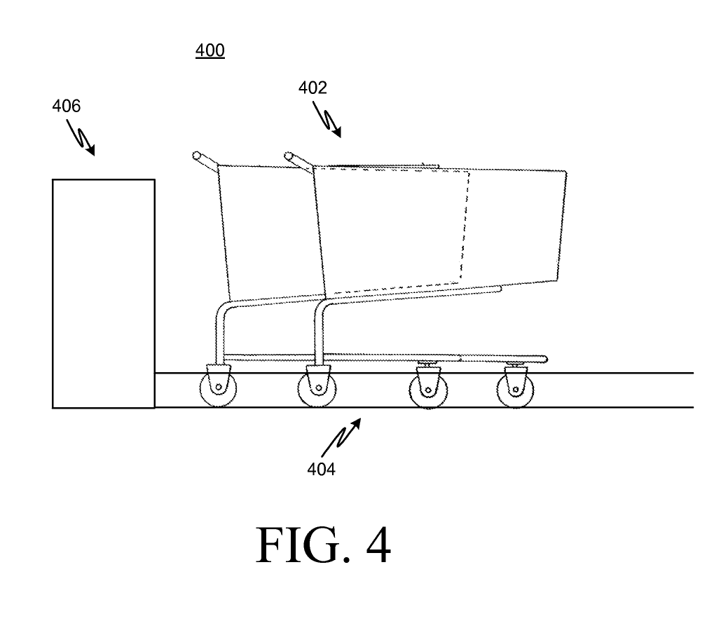

FIG. 4 shows a shopping cart dispensing system 400 in which a plurality of shopping carts 402 are in a track 404. The track 404 is controlled by dispensing machine 406. The dispensing machine 406 can cause the track 404 to mechanically release a shopping cart 402 when a customer has provided a proper identification and/or payment to the dispensing apparatus 406. For example a customer may provide a government issued I.D. or a store issued I.D. card that identifies the customer as a customer needing a wheelchair adapted shopping cart when shopping. This way the wheelchair adapted shopping carts remain reserved and dispense only to those customers who actually demonstrate a need for the shopping cart by presenting the appropriate identification card. It will also be appreciated that another form of I.D. or payment card could be used such as a debit card or a credit card and that such debit or credit card could be used as an identification of the customer needing to use a wheelchair adapted shopping cart. A payment may or may not be charged. Any card could be used for identification purposes only. In addition to, or as an alternative to, cards, other types of identification could be used such as biometric, radio frequency identification (RFID) or the like.

When the shopping carts 402 are nested and stored in the dispensing apparatus 400, the track 404 in addition to locking the shopping carts in place mechanically can also provide electrical power to recharge the shopping carts if the shopping carts contain electrical apparatus such a power assist unit and/or a display unit.

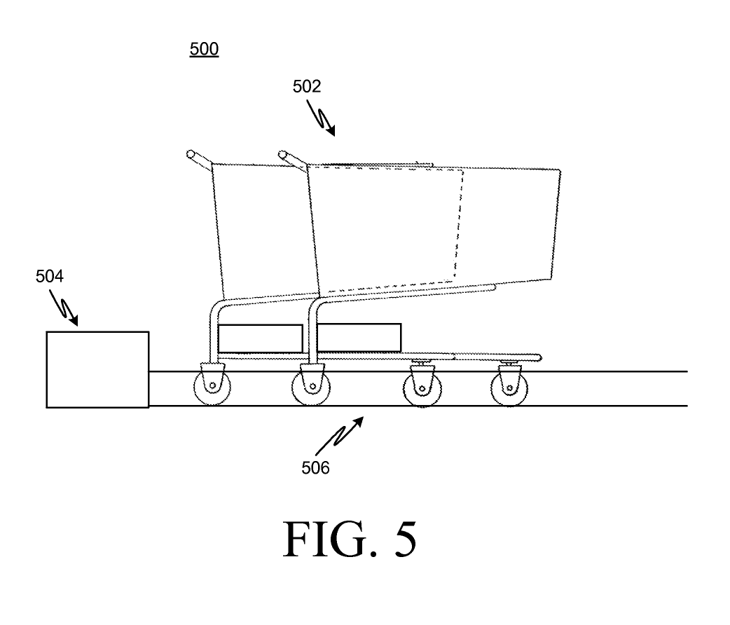

FIG. 5 shows a shopping cart recharging station and/or docking system 500 in which shopping carts 502 have been nested and inserted into the charging and docking station 506 and a charging apparatus 504 is connected to the docking station 506 to recharge the shopping carts 502.

FIG. 6 shows a power assisted shopping cart system 600 having a wheelchair adapted shopping cart 602, a power assist unit 604, wheel chair attachment member 606 and a basket gate handle 608. The power assist unit 604 can include a battery, a control module and an electrical motor along with mechanical components (e.g., a belt or gear drive) that permit the electrical motor to provide power assist to the wheels of the shopping cart and/or to drive an additional drive wheel to provide additional force to the shopping cart.

The power assist unit 604 can include sensors that measure the speed of the shopping cart and seek to match the speed of the shopping cart with the electrical motor thereby maintaining the same speed as a customer is moving at but lessening the load experienced by the customer which will in turn take the burden off of the customer in the wheelchair as they are using the wheelchair adapted shopping cart. It will be appreciated that a power-assisted cart may not be needed when a person is using a power-assisted wheelchair.

FIG. 7 shows a side elevation view of a wheelchair (e.g., powered or manual wheelchair) coupled to a small-basket shopping cart adapted for use with a wheelchair in accordance with at least one embodiment. The shopping system 700 includes a wheelchair 106, connecting member 708, small-basket shopping cart 702 having an upper basket 704 and a frame 706.

It is, therefore, apparent that there is provided in accordance with the presently disclosed subject matter, a shopping cart system. While this disclosed subject matter has been described in conjunction with a number of embodiments, it is evident that many alternatives, modifications and variations would be or are apparent to those of ordinary skill in the applicable arts. Accordingly, applicant intends to embrace all such alternatives, modifications, equivalents and variations that are within the spirit and scope of the disclosed subject matter.

What is claimed is:

1. A shopping cart comprising:
a basket having a rear panel that is releasably fixed in a first position and can be released from the first position and lowered to a second position; and
a plurality of attachment members adapted to attach to the frame of a wheelchair.

2. The shopping cart of claim 1, wherein the shopping cart is adapted to nest in another shopping cart for storage.

3. The shopping cart of claim 2, further comprising: a power assist module, the power assist module including a battery, a control module and an electric motor coupled to a drive wheel to provide power assist to a user of the shopping cart.

4. The shopping cart of claim 3, wherein the shopping cart is adapted to releasably engage a track of a cart dispensing system.

5. A shopping cart dispensing system comprising:
a track adapted to receive a plurality of shopping carts and mechanically lock the shopping carts in place; and
a dispensing unit adapted to dispense one of the shopping carts by releasing a mechanical lock when appropriate identification is presented to the dispensing module,
wherein each shopping cart includes a basket having a rear panel that is releasably fixed in a first position and can be released from the first position and lowered to a second position; and
a plurality of attachment members adapted to attach to the frame of a wheelchair.

6. The shopping cart dispensing system of claim 5, wherein appropriate identification includes information that a person attempting to retrieve a shopping cart has a need to use a shopping cart adapted for use with a wheelchair.

7. A power assisted shopping cart comprising:
a shopping cart; and
a power assist module, the power assist module including a battery, a control module and an electric motor coupled to a drive wheel to provide power assist to a user of the shopping cart,
wherein the shopping cart includes a basket having a rear panel that is releasably fixed in a first position and can be released from the first position and lowered to a second position such that the rear panel extends toward an exterior of the basket; and
a plurality of attachment members adapted to attach to the frame of a wheelchair.
